(19) United States
(12) Patent Application Publication
(10) Pub. No.: US 2017/0142975 A1
(43) Pub. Date: May 25, 2017

(54) POLYDOPAMINE FUNCTIONALIZED CELLULOSE NANOCRYSTALS (PD-CNCS) AND USES THEREOF

(71) Applicant: CELLUFORCE INC., Montréal, Québec (CA)

(72) Inventors: Zengqian SHI, Waterloo, Ontario (CA); Juntao TANG, Waterloo, Ontario (CA); Kam Chiu TAM, Waterloo, Ontario (CA); Richard BERRY, Notre-Dame-de-L'Ile Perrot, Québec (CA)

(73) Assignee: CELLUFORCE INC., Montréal, Québec (CA)

(21) Appl. No.: 15/327,492

(22) PCT Filed: Jul. 17, 2015
(86) PCT No.: PCT/CA2015/050669

§ 371 Date: Jan. 19, 2017

Related U.S. Application Data
(60) Provisional application No. 62/027,319, filed on Jul. 22, 2014.

(51) Int. Cl. A01N 59/16; B01J 37/16; B01J 37/02; A01N 25/26; B01J 31/26

(52) U.S. Cl. CPC A01N 59/16; A01N 25/26; B01J 31/26; B01J 37/0244; B01J 37/16

(57) ABSTRACT

The present disclosure relates to use of polydopamine (PD) coated cellulose nanocrystals (CNCs) as template for further conjugation of functional oligomers (amines, carboxylic acids etc.) and the immobilization of various types of CNC hybrid nanomaterial nanoparticles to improve their stability in aqueous solution, e.g. the preparation of silver nanoparticle on CNC. Surface functionalization of CNC with polydopamine can be performed by mixing dopamine and CNCs for certain time at designed temperature. The resultant PD-CNCs can be used to stabilize metallic and inorganic nanoparticles, which could be generated in-situ, and further immobilized on the surface of PD coated CNCs. Benefiting from the improved stability, the resultant nanoparticles immobilized PD-CNC system also generally possess higher catalytic activity than the nanoparticles alone.

### FIELD OF THE DISCLOSURE

The present disclosure relates to the synthesis and use of polydopamine (PD) functionalized cellulose nanocrystals (CNCs) (PD-CNC).

### BACKGROUND OF THE DISCLOSURE

Hybrid nanoparticles were found to possess excellent antimicrobial or catalytic activities on a wide range of reactions. The involved metallic nanomaterial included nanoparticles from Palladium (Pd), Platinum (Pt), Gold (Au), Silver (Ag), and so on. (Didier Astruc, Nanoparticles and Catalysis, 2008, Wiley-VCH Verlag GmbH & Co. KGaA, Federal Republic of Germany).

Certain nanomaterials, like silver nanoparticle (AgNP) may be multifunctional. On the one hand, silver nanoparticle (AgNP) is highly effective against a wide range of bacteria, hence it is widely used in water purification, (Dankovich, T. A; et al. Environ. Sci. Technol. 2011, 45, 1992-1998.) food preservation, (Mohammed, F. et al. Agric. Food Chem. 2009, 57, 6246-6252.) and cosmetics (Kokura, S. et al Nanomedicine 2010, 6, 570-574) with low toxicity to human cells and low volatility. (Duran, N. et al. J. Biomed. Nanotechnol. 2007, 3, 203-208.). In contrast to chemical based antimicrobial agents, AgNP is also considered to be a promising candidate to kill bacteria without antibiotic resistance challenges. (Rai M.; et al. J. Appl. Microbiol. 2012, 112, 841-852.). On the other hand, AgNP had been extensively studied based on its strong reducing activity, like its catalytic reduction of nitrophenols and nitroanilines (Ai, L. et al. J. Mater. Chem. 2012, 22, 23447-23453.).

AgNPs are commonly fabricated through the reduction of silver nitrate, and stabilized by capping agents. Therefore, stabilization of the nanoparticles to minimize aggregation arising from the high surface area of the nanomaterials is prerequisite for maximizing their catalytic properties. However, most of the capping agents are non-biodegradable polymers or toxic chemicals except for polysaccharides.

Cellulose nanocrystals (CNCs) are obtained by the acid hydrolysis of native cellulose using an aqueous inorganic acid like sulphuric acid. Upon the completion (or near completion) of acid hydrolysis of the amorphous sections of native cellulose, individual rod like crystallites called CNCs that are insensitive to acidic environment are obtained (Landry, V. et al. For. Prod. J. 2011, 61, 104-112). CNC possesses excellent mechanical properties, biodegradability and biocompatibility with a diameter in the range of 10-20 nm and length of a few hundred nanometers. (Peng, B. L. et al. Can. J. Chem. Eng. 2011, 89, 1191-1206). CNC also has a high surface area of ˜500 m²/g, (Heath, L. et al. Green Chem. 2010, 12, 1448-1453.)

The hydrolysis of cellulose using sulphuric acid leads to the formation of sulfate ester groups generating numerous negative charges on the surface of CNCs. These negative charges on the surface of CNCs promote uniform dispersion of nanocrystals due to electrostatic repulsion in aqueous solutions. (Samir, M.A.S.A. et al/ Biomacromolecules 2005, 6, 612-626).

### SUMMARY OF THE DISCLOSURE

In one aspect, there is provided a method for producing polydopamine (PD) coated cellulose nanocrystals (CNCs), or a derivative thereof, comprising:
dispersing CNC in an aqueous medium;
optionally adjusting the pH such that it is suitable for the coating to occur on said CNC,
adding dopamine, or a suitable salt thereof;
allowing the polydopamine coating to occur on said CNC, and
isolating said PD coated CNC,

wherein a step of derivatizing said PD coating is optionally conducted before or after the step of isolation of said PD coated CNC.

In a further aspect, there is provided a polydopamine (PD) coated cellulose nanocrystals (CNCs) as defined herein.

In one aspect, there is provided a method for producing metallic nanoparticles immobilized on PD coated CNC, or a derivative thereof, comprising:
contacting the PD coated CNC, or a derivative thereof, described herein with a metallic ion or particle source;
optionally adding dopamine, or a suitable salt thereof;
allowing reduction of said metallic particle source and immobilization on said PD coated CNC to occur; and
isolating said metallic nanoparticles immobilized on PD coated CNC.

In one further aspect, there is provided a polydopamine (PD) coated cellulose nanocrystals (CNCs) comprising metallic nanoparticles immobilized thereon as defined herein.

In one aspect, there is provided an antimicrobial agent comprising polydopamine (PD) coated cellulose nanocrystals (CNCs), or a derivative thereof, comprising metallic nanoparticles immobilized thereon.

In one aspect, there is provided a method for reducing or inhibiting the antibacterial activity of a bacteria comprising contacting said bacteria with an antibacterial agent containing an effective amount of a polydopamine (PD) coated cellulose nanocrystals (CNCs), or a derivative thereof, comprising metallic nanoparticles immobilized thereon.

In one aspect, there is provided a method for enhancing the antibacterial activity of the compounds by contacting said bacteria with an antibacterial agent containing an effective amount of a polydopamine (PD) coated cellulose nanocrystals (CNCs), or a derivative thereof, comprising metallic nanoparticles immobilized thereon.

In one aspect, there is provided a catalyst comprising a polydopamine (PD) coated cellulose nanocrystals (CNCs), or a derivative thereof, comprising a metallic nanoparticles immobilized thereon.

In one aspect, there is provided a method for reducing a substrate, comprising contacting said substrate with a polydopamine (PD) coated cellulose nanocrystals (CNCs), or a derivative thereof, comprising metallic nanoparticles immobilized thereon.

### DESCRIPTION OF THE DRAWINGS

The present disclosure is illustrated with reference to the following drawings, in which:

FIG. 1 is a schematic representation of the mechanism of preparation of PD-CNCs and Ag-PD-CNCs.

FIG. 2 is the TEM images of CNC (a) and, PD-CNC with feed ratios of DP:CNC=1:1 (b). The scale bars are 100 nm.

FIG. 3 is the TGA curves of CNC, PD-CNC and Ag-PD-CNC.

FIG. 4 is the UV-Vis spectra of PD-CNC and Ag-PD-CNC.

FIGS. 5(a) and 5(b) are the TEM images of Ag-PD-CNC (a) and pure AgNPs (b). The scale bars are 100 nm.

FIGS. 6(A)-6(D) are UV-Vis spectra for monitoring the reduction of 4-nitrophenol catalyzed by pure AgNPs (A) and Ag-PD-CNC (B); the plot of absorption intensity vs time at 400 nm (C) and ln(Cₜ/C₀) vs time (D) for pure AgNPs and Ag-PD-CNC systems.

### DETAILED DESCRIPTION OF THE DISCLOSURE

The present disclosure relates to the synthesis and use of polydopamine (PD) functionalized cellulose nanocrystals (CNCs) (PD-CNC), where the PD acts as a substrate for further conjugation with various functional moieties (e.g. amines, carboxylic acids etc.), and also to immobilize metallic and inorganic nanoparticles. Examples of the application of PD-CNC hybrid systems include, without limitation, antimicrobial agent flocculation agent, and novel hybrid catalyst.

As provided in this disclosure, the water dispersible CNCs were functionalized by spontaneous self- polymerization of dopamine on the surface of CNCs, and then metallic nanoparticles, such as silver nanoparticles, were in-situ generated and immobilized on the surface of PD-CNC. The AgNPs stabilized with PD-CNC possessed antibacterial and reducing properties. It is believed that the favorable effect is due to the improved dispersibility and stability induced by CNC in aqueous solution.

It is believed that the following advantages may be derived from the present disclosure:
CNCs have favorable water dispersibility and high surface area which render the CNCs an ideal media to stabilizing the non-soluble or unstable materials such as AgNPs.
the functionalization of CNCs with PD in water is believed to endow the CNCs surface with reducing and chelating properties to metal ions which facilitate the generation and immobilization of general metal nanoparticles.
the immobilization of metal nanoparticles (such as AgNPs) on the PD-CNCs may improve the solution stability of nanoparticles, and further improve the antimicrobial activity of the nanoparticles.
the immobilization of nanoparticles (such as AgNPs) on the PD-CNCs can improve the solution stability of said nanoparticles, and further enhance the catalytic activity of the metal.
the conjugation of various functional groups onto PD-CNC to yield functional CNC can be readily achieved in green solvents under mild conditions.

The present disclosure therefore provides a method for producing polydopamine (PD) coated cellulose nanocrystals (CNCs), comprising:
dispersing CNC in an aqueous medium;
optionally adjusting the pH such that it is suitable to allow the coating to occur on said CNC,
adding dopamine, or a suitable salt thereof;
allowing the polydopamine coating to occur on said CNC, and
isolating said PD coated CNC.

In the above method, a step of derivatizing said PD coating is optionally conducted before or after the step of isolation of said PD coated CNC

Preferably, in the above method for producing PD coated CNC, the aqueous medium is deionized water. Preferably, the concentration of CNC in water is ranging 0.1-4.0 wt %, or 0.20-2.0 wt %. Preferably, in the above method for producing PD coated CNC, the pH is from about 7 to 9. More preferably, the pH is about 8.

Preferably, in the above method for producing PD coated CNC, the dopamine is used in an amount of about 0.1-4.0 wt %, more preferably 0.2-2% wt %. The dopamine can be dopamine hydrochloride. Among other, tris((hydroxymethyl)aminomethane) can be used to adjust the pH to about 7 to 9, or preferably about 8.0.

Preferably, in the above method for producing PD coated CNC, the step of isolation of said PD coated CNC is comprising centrifugation or filtration, preferably ultrafiltration.

In one embodiment of the method for producing polydopamine (PD) coated cellulose nanocrystals (CNCs), a further optional step comprises derivatizing the PD before or after the isolation step.

CNC-PD derivatization can be performed under many physical (such as compound or metal complexation) and chemical (such as Michael addition acceptor) conditions, not limited to CNC-inorganic hybrids, many organic compounds can further react with the catechols and its derivatives in PD to prepare many types of functional CNC in aqueous and green solvent under mild conditions. (see Faure, E. et al., Catechols as versatile platforms in polymer chemistry, Progress in Polymer Science, 2013, 38, 236-270). In the context of this disclosure, the reference to PD coated CNC “or a derivative thereof” relates to the derivatives of the PD portion. Some of the involved reactions are illustrated in Scheme 1 below.

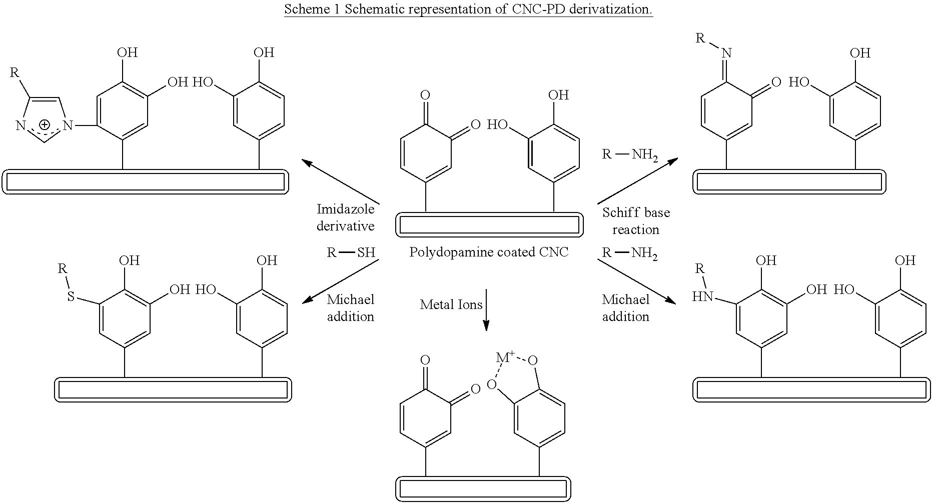

In one aspect, there is provided a polydopamine (PD) coated cellulose nanocrystals (CNCs) or a derivative thereof as prepared by the method defined herein.

In one aspect, there is provided a polydopamine (PD) coated cellulose nanocrystals (CNCs) or a derivative thereof as defined herein.

The strong adhesive property of PD has been reported in many studies. (See Lee, H.; Dellatore, S. M.; Miller, W. M.; Messersmith, P. B. Mussel-Inspired Surface Chemistry for Multifunctional Coatings. Science 2007, 318, 426-430.) However, the reaction to form PD is complicated. The exact reaction mechanism is still being debated. (See Della Vecchia, N. F.; Avolio, R.; Alfè, M.; Errico, M. E.; Napolitano, A.; and d′Ischia, M. Building-block diversity in polydopamine underpins a multifunctional eumelanin-type platform tunable through a quinone control point. Adv. Funct. Mater. 2013, 23, 1331-1340.) A detailed investigation has been reported recently by Sebastian and co-workers using ¹³C CPPI (cross-polarization polarization inversion) MAS NMR (cross-polarization polarization—inversion magic angle spinning NMR), ¹H MAS NMR (magic angle spinning NMR), and ES-HRMS (electrospray ionization high-resolution mass spectrometry), XPS (X-ray photoelectron spectroscopy) and FTIR spectroscopy. It showed that the most possible structure of PD consists of dihydroxyindole and indoledione units with different degrees of (un)saturation, these two units are covalently connected using C—C bonds through benzene rings from dopamine. (See Liebscher J.; Mrówczyński, R.; Scheidt, H. A.; Filip, C.; H\check{a}dade, N. D.; Turcu, R.; Bende, A.; Beck, S., Structure of Polydopamine: A Never-Ending Story? Langmuir 2013, 29, 10539-10548.)

The present disclosure also provides a method for producing metallic nanoparticles immobilized on PD coated CNC, comprising:
contacting the PD coated CNC, as described/prepared herein with a metallic particle source;
optionally adding dopamine, or a suitable salt thereof;
allowing reduction of said metallic particle source and immobilization on said PD coated CNC to occur; and
isolating said metallic nanoparticles immobilized on PD coated CNC.

The present disclosure also provides a method for immobilizing metallic nanoparticles on PD coated CNC, or a derivative thereof, comprising:
contacting the PD coated CNC, or a derivative thereof, as described/prepared herein with a metallic particle source;
optionally adding dopamine or a suitable salt thereof;
allowing reduction of said metallic particle source and immobilization on said PD coated CNC to occur; and
isolating said metallic nanoparticles immobilized on PD coated CNC.

Preferably, in the above method for producing metallic nanoparticles immobilized on PD coated CNC, the metallic nanoparticles are metal (0) (may contain small amounts of metal oxide because the surface oxidation may occur when the metal (0) is exposed to air. Preferably the metallic nanoparticles are silver, gold, platinum (Pt), palladium (Pd). More preferably, the metal is silver.

As used herein, a “metallic particle source” is a metal compound that can suitably be reduced in the process to produce metallic nanoparticles. An example of this is a Ag (I) compound such as a silver diamine compound obtained by reacting silver nitrate with NH₃.

In the above method for producing metallic nanoparticles immobilized on PD coated CNC, an amount of dopamine (or a salt) can be added to facilitate the reaction in a short time. The suitable amount of dopamine can be adjusted. An exemplary range of dopamine calculated on a sliver nitrate basis could be ranging 0.0-50.0 wt % dopamine based on the amount of sliver nitrate. More preferably 5.0-30.0 wt % of the amount of silver nitrate.

In one aspect, there is provided a polydopamine (PD) coated cellulose nanocrystals (CNCs) comprising metallic nanoparticles immobilized thereon prepared by the process as defined herein.

In one aspect, there is provided a polydopamine (PD) coated cellulose nanocrystals (CNCs) comprising metallic nanoparticles immobilized thereon as defined herein.

In one embodiment, there is provided a polydopamine (PD) coated cellulose nanocrystals (CNCs) comprising silver nanoparticles immobilized thereon prepared by the process as defined herein.

In one embodiment, there is provided a polydopamine (PD) coated cellulose nanocrystals (CNCs) comprising silver nanoparticles immobilized thereon as defined herein.

In one aspect, there is provided an antimicrobial agent comprising polydopamine (PD) coated cellulose nanocrystals (CNCs) comprising metallic nanoparticles immobilized thereon, as defined herein.

It is believed that the antimicrobial agent may be used without particular limitation to microorganism susceptible of being affected by the action of “antibacterial” metallic nanoparticles such as Ag, Au and other related metals. The microbes can be organism such as bacteria, and may extend to protozoas as well as fungis, algaes. The antimicrobial agent described herein may be especially useful with pathogenic micro-organisms. The antimicrobial agent can be used alone or compounded or admixed with common acceptable carriers and excipient.

In one aspect, there is provided a method for treating a microorganism, comprising contacting said microorganism with a polydopamine (PD) coated cellulose nanocrystals (CNCs) comprising a metallic nanoparticles immobilized thereon as defined herein. In one embodiment, the microorganism is a bacterium. In a further embodiment, the bacterial is Gram-positive. In a further embodiment, the bacterial is Gram-negative.

As used herein, the expression “treating a microorganism” is contemplated as including an inhibition, in part or completely, of the growth of the microorganism colony.

In one aspect, there is provided a method for catalysing a reaction, comprising contacting a polydopamine (PD) coated cellulose nanocrystals (CNCs) comprising a metallic nanoparticles immobilized thereon with reagents of said reaction.

In relation to the method for catalysing a reaction as defined herein, the reaction is a reduction reaction. Preferably, the reduction is a hydride reductor based (such as a borohydride, including sodium borohydride) reduction.

In one embodiment, the immobilized metallic nanoparticle is a noble metal, preferably Ag.

In one aspect, there is provided a catalyst comprising a polydopamine (PD) coated cellulose nanocrystals (CNCs) comprising a metallic nanoparticles immobilized thereon.

In the examples below CNCs were obtained from Celluforce Inc. (Montreal, Quebec Canada). Dopamine hydrochloride, silver nitrate, ammonia hydroxide solution, and tris((hydroxymethyl)aminomethane) were purchased from Sigma-Aldrich Co. Nutrient broth powder (OptiGrow™ Preweighed LB Broth, Lennox) was purchased from Thermo Fisher Scientific Inc. Plate Count Agar (Difco™ Ref. 247940) was purchased from Becton Dickinson and Company. All the chemicals were used as received. E. coli and B. subtilis bacteria were provided by the teaching lab at Department of Chemical Engineering, University of Waterloo.

### EXAMPLE 1

### PD Functionalization of CNCs I

The coating process is as follows: 1.0 g of CNC was dispersed in 500 mL deionized water using Branson™ 1510 sonicator (Branson Ultrasonic Corporation, USA) for 15-20 minutes, and 0.6 g of tris((hydroxymethyl)aminomethane) was introduced into the CNC solution to adjust the pH to ˜8.0. Then 1.0 g of dopamine hydrochloride was added. The reaction was performed at room temperature for 0.5-3 days (preferred 1-2 days) under ambient atmosphere. At the end of the reaction, the products were purified in an ultrafiltration cell equipped with a 0.1 μm pore size filtration membrane and they were washed several times with 200 mL deionized water until the filtrate became clear. Pure polydopamine (PD) was prepared at the same condition without CNC. The resultant PD was purified by dialysis against deionized water for 7 days with a dialysis tube (cut-off molecular weight is 12,000), and then dried in a vacuum oven at 60° C. for 24 h.

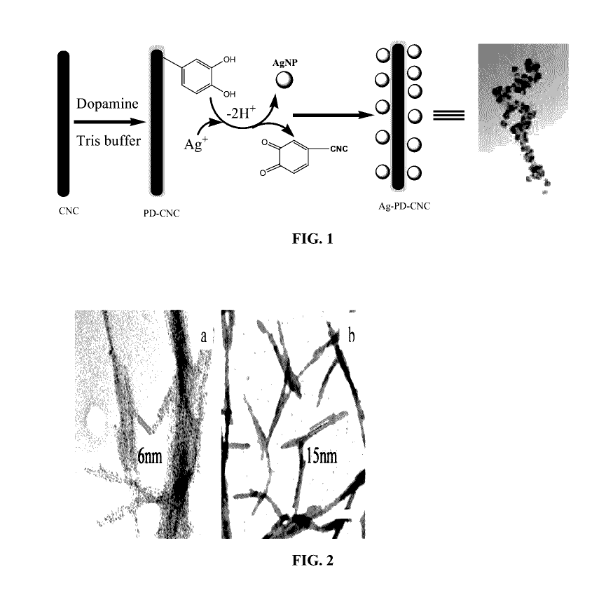

The schematic representation of a possible mechanism for fabrication of PD modified CNCs was illustrated in FIG. 1. The morphology of resultant PD-CNC was characterized by TEM images shown in FIG. 2. Compared to pristine CNC with diameter around 6 nm, the diameter of PD-CNC evidently increased to around 15 nm, indicate the successful coating.

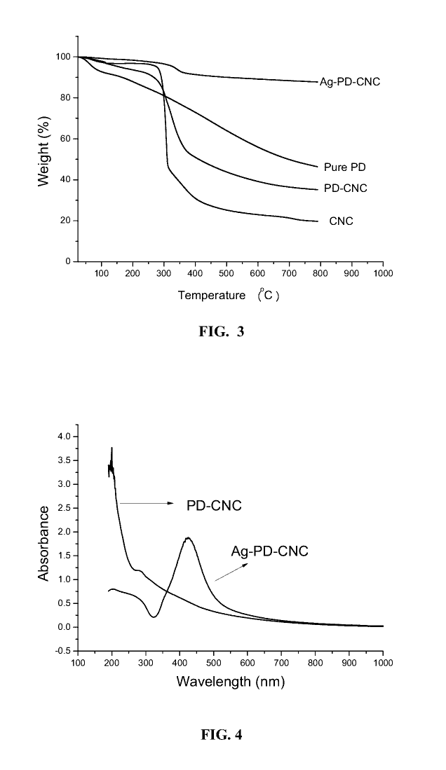

Furthermore, the content of PD in PD-CNC was determined by TGA as shown in FIG. 3. At 800° C., the residue was 20%, 35.1% and 51.3% for pristine CNC, PD-CNC and pure PD. Thus, the content of PD in PD-CNC was calculated to be 48.2% based on the following equations:

C_{CNC}+C_{PD}=1

0.2C_{CNC}+0.513C_{PD}=0.351

where, C_{CNC} is the content of CNC in PD-CNC, and C_{PD} is the content of PD in PD-CNC.

### EXAMPLE 2

### PD Functionalization of CNCs II

Another typical procedure is described as follows: 1.0 g of CNC was dispersed in 100 mL deionized water using the above sonicator, and 0.3 g of tris((hydroxymethyl)aminomethane) was introduced into the CNC solution to adjust the pH to ˜8.0. Then 1.0 g of dopamine hydrochloride was added. The reaction was performed at 60° C. for 1-5 hours (preferred 3 hours) under ambient atmosphere. At the end of the reaction, the products were purified in an ultrafiltration cell equipped with a 0.1 μm pore size filtration membrane and they were washed for couple of times with 100 mL deionized water until the filtrate became clear.

### EXAMPLE 3

### Fabrication of A₂NPs Immobilized CNCs

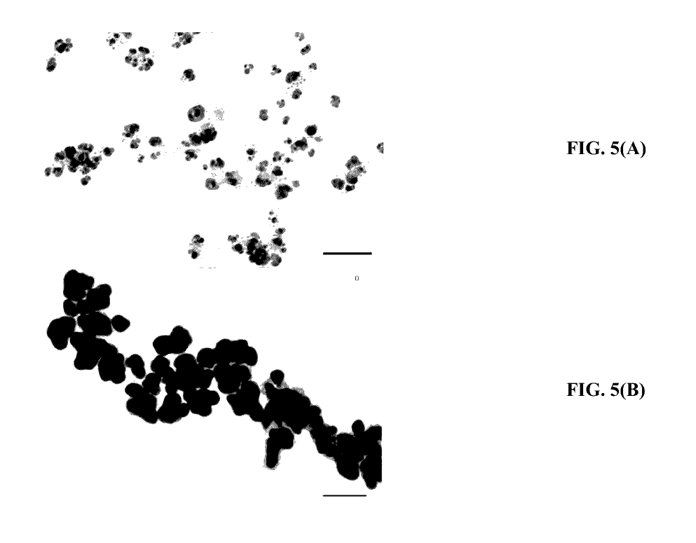

Fabrication and Immobilization of AgNPs was achieved by the following two-step protocol: First, 50.0 mg of silver nitrate was introduced into 20 mL deionized water, and then ammonia in water solution (3.0 wt %) was slowly added to the above sliver nitrate solution until the solution became clear indicating that the diamine silver (I) was formed. Then 0.5 mL of PD-CNC solution (3.0 wt %) was added to the resultant diamine silver (I) solution and stirred at RT for 1 h followed by the addition of 4.0 mg of dopamine hydrochloride (in 1.0 mL deionized water) that facilitates the reduction of silver ions. After 0.5-5 hours (preferred 1-2 h), the product was purified by centrifugation at 8000 rpm for 10 min, then washed with deionized water for 3 times. The final product was characterized by TGA (FIG. 3), UV-Visible Spectroscopy (FIG. 4) and TEM (FIG. 5a). The successful generation of AgNPs was confirmed by UV-Visible spectroscopy as shown in FIG. 4. The peak located at approximate 420 nm in the UV spectrum is a typical peak for AgNPs. Furthermore, the content of silver in Ag-PD-CNC was determined by TGA as shown in FIG. 3. At 800° C., the residue was 20.0, 35.1 and 87.6% for pristine CNC, PD-CNC and Ag-PD-CNC. Thus, the content of AgNPs in Ag-PD-CNC was calculated to be 81% based on the following equations:

C_{Ag}+C_{PD-CNC}=1

C_{Ag}+0.351C_{PD-CNC}=0.876

where, C_{Ag} is the content of silver in Ag-PD-CNC, and CPD-CNC is the amount of PD-CNC in Ag-PD-CNC.

The morphology of resultant Ag-PD-CNC. It is clearly evident that all the AgNPs were deposited on the surface of PD-CNC as shown in FIG. 5a.

### EXAMPLE 4

### Preparation of Pure A2NPs by Dopamine Hydrochloride

Pure AgNPs was prepared using the following protocol: 50.0 mg of silver nitrate was introduced into 20 mL deionized water, and an ammonia solution (3.0 wt %) was slowly added to the solution until the solution became clear indicating that diamine silver (I) was formed. Then 4.0 mg of dopamine hydrochloride (in 1.0 mL deionized water) was introduced into the foresaid diamine silver (I) solution to reduce silver ion. After 2 hours, the product was purified by centrifugation at 8000 rpm for 10 min, then washed with deionized water for 3 times. The final product was characterized by TEM (FIG. 5b). FIG. 5b shows the pure AgNPs generated by dopamine tended to form large clusters of approximately 20-50 nm when dried on the copper grid for TEM test, which is consistent with the inherent aggregation characteristics of AgNPs.

A comparison of the stability of AgNPs and Ag-PD-CNC solution (a) after preparation and, (b) after one week showed an improved stability of Ag-PD-CNC by the comparison of the water media.

### EXAMPLE 5

### Antimicrobial Evaluation

The antibacterial activity of resultant AgNps and Ag-PD-CNC was evaluated by determining their minimum inhibition concentration (MIC) to Gram-negative (E. Coli) and Gram-positive (Bacillus Subtilis) bacteria, respectively. The detailed protocol is described below:

1) Agar Plates and Nutrient Broth (2.0 g/L) Preparation

11.75 g agar powder was dissolved in 500 mL deionized water. 1.0 g nutrient broth was dissolved in 500 mL deionized water. Both were sterilized in an autoclave for 30 mins. The agar plates were prepared with the hot agar solution in a sterile environment using sterilized Petri dishes that were stored in fridge at 4° C. prior to use.

2) Bacteria Culture

First, the bacteria was cultured in nutrient broth at 35° C. for 12 h, and then the bacteria solution was diluted with nutrient broth until the UV absorption was between 0.07-0.08 at 600 nm.

### 3) Antibacterial Solution Preparation

The Ag-PD-CNC (prepared in accordance with example 3 above) and pure AgNPs (prepared in accordance with example 4) solutions were prepared in concentrations ranging from 32 μg/mL to 0.5 μg/mL. All the concentrations were calculated based on the mass of Ag. The mass of PD-CNC was deducted from Ag-PD-CNC, so that the AgNPs solution and Ag-PD-CNC solution had exactly the same weight concentration based on the mass of silver.

4) Incubation

1.0 mL nutrient broth was mixed with 1.0 mL Ag-PD-CNC solution and 10 μL of bacteria solution in a sterilized 15 mL plastic centrifuge tube. The control sample was prepared using the same protocol, but the Ag-PD-CNC solution was replaced by deionized water. The solution was then placed onto a shaking bed kept at 90 rpm and maintained at 37° C. for 4 hrs.

5) Antibacterial Property Evaluation

After incubation, 0.1 mL of resultant bacteria containing solution was transferred onto the surface of an agar plate in a sterile environment, and spread the solution carefully to cover the whole surface homogeneously by sterilized glass rod. Then all the agar plates were placed in an oven for colony growth at 35° C. overnight.

The minimum inhibition concentration (MIC) was determined according the lowest AgNPs and Ag-PD-CNC concentrations that inhibited the visible growth of microbes after incubation overnight. The bacteria colony growth in different concentrations of antimicrobial agent was assessed.

For the E. Coli system, the impact of two AgNP systems on the growth of bacteria colony was measured. The density of bacteria colony decreased with increasing AgNPs concentration. The E. Coli colony was completely eliminated when the concentration of Ag-PD-CNC is 4 μg/mL. While, for the pure AgNPs, the colony disappeared when the concentration is 16 μg/mL. The MIC for pure AgNPs is between 8-16 μg/mL compared to 2-4 μg/mL for Ag-PD-CNC. Indeed, the antibacterial activity of Ag-PD-CNC is approximately four times better than AgNPs when the same payload of silver was used with E. Coli.

For Bacillus Subtilis system, the antibacterial test results were also measured. In the pictures, the density of bacteria colony decreased gradually along with the increase of AgNPs concentration. The colony was completely eliminated when the concentration of Ag-PD-CNC was 8 μg/mL. While, for the pure AgNPs sample, the colony disappeared only when the concentration was 32 μg/mL. The MIC for pure AgNPs was between 16-32 μg/mL, and it was 4-8 μg/mL for Ag-PD-CNC. Thus, the antibacterial activity of Ag-PD-CNC is about four times better than that of AgNPs for Bacillus Subtilis bacterium.

To compare the antibacterial property of the present system with other systems under similar conditions, a summary of the MIC of our system and a system prepared by electrochemical method without surfactants is summarized in Table 1. (Khaydarov, R. R.; et al. Silver Nanoparticles. In Nanomaterials: Risks and Benefits; Linkov, I., Steevens J., EDs.; NATO Science for Peace and Security Series C: Environmental Security; Springer: The Netherlands, 2009; 287-297.) All the AgNPs have a comparable particles size, 7 nm in average, without the addition of surfactants, only the Ag-PD-CNC was stabilized by CNC. The results indicated that for E. Coli, the Ag-PD-CNC had almost the same MIC with other study, they were all between 2-4 _{f}ig (Ag)/mL. While for the B. Subtilis, the MIC of Ag-PD-CNC was almost four-time lower than the other report, it was 4-8 μg (Ag)/mL for Ag-PD-CNC and 19 μg (Ag)/mL from the literature which has consistent MIC with the AgNPs prepared by dopamine.

As shown in Table 1, the Ag-PD-CNC system displayed antibacterial activity that is four times better than pure AgNPs on both the Gram-positive and Gram-negative bacteria.

TABLE 1

| | MIC (μg(Ag)/mL)* | MIC (μg(Ag)/mL) | MIC (μg(Ag)/mL) |
|---|---|---|---|
| Bacterium | (other's work) | (Ag-PD-CNC) | (Pure AgNPs) |
| E. Coli | 3 | 2-4 | 8-16 |
| B. Subtilis | 19 | 4-8 | 16-32 |

*preparation method see: Khaydarov, R. R.; et al. cited above.

### EXAMPLE 6

### Evaluation of Reduction Activity

4-nitrophenol (4-NP) was selected as a model reaction for evaluating the catalytic efficiency of hybrid Ag-PD-CNC nanocatalyst. First, solution 1 (12 mM 4-NP) was prepared by dissolving 16.7 mg of 4-NP powder in 10 mL deionized water as stock solution 1. Second, solution 2 containing 0.12 mM 4-NP (diluted from stock solution 1) and 38 mM NaBH₄ was prepared for the reduction experiment. After preparation, immediately, 3 mL of solution 2 was introduced into a UV cuvette and then tested by UV-Visible spectroscopy equipped with thermostated cell. Then, 200 μL of catalyst solution (silver content is 2.0 μg/mL) was added to solution 2 using Eppendorf pipette and mixed for 5 s. Immediately, the reaction was monitored using UV-Visible spectrometry in range of 250-600 nm at 25° C. with an interval of 1 min. The experiment using AgNPs alone was run under the identical conditions as parallel.

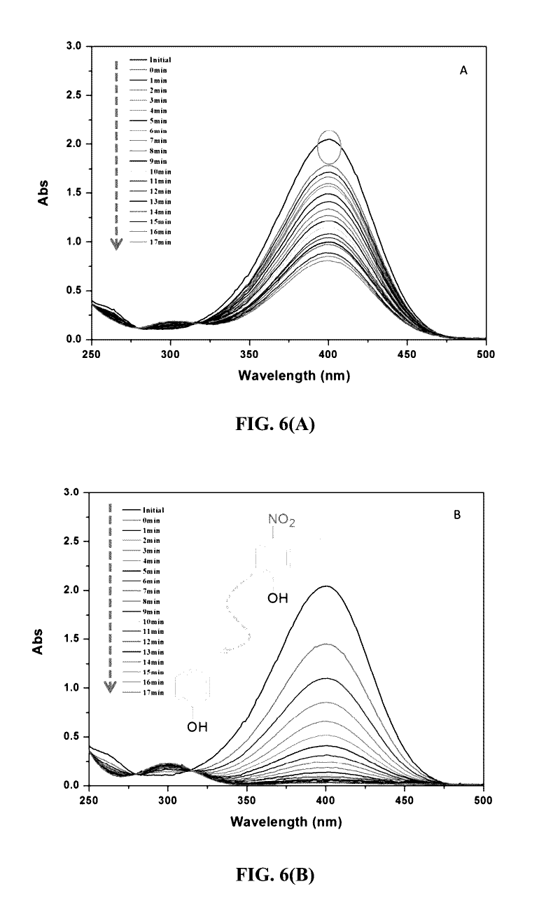

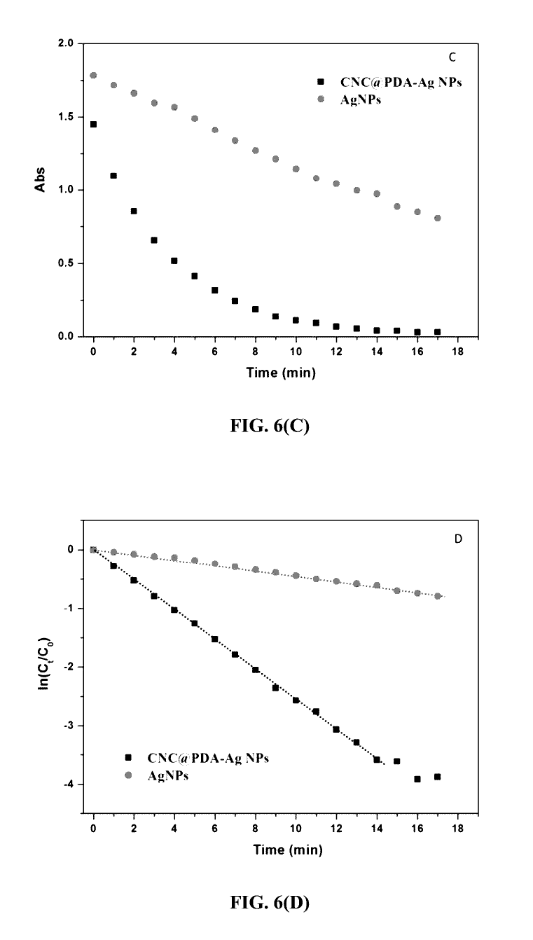

Initially, the absorbance peak of 4-NP in an aqueous solution of NaBH₄ is at 400 nm. It showed a yellow-green color due to the formation of 4-nitrophenolate ion. (Liu, P.; Zhao, M. Silver nanoparticle supported on halloysite nanotubes catalyzed reduction of 4-nitrophenol (4-NP). Appl. Surf. Sci. 2009, 255, 3989-3993.) Upon the starting of reduction, a small peak at 297 nm can be observed and became bigger and bigger indicating that the nitrophenol was gradually converted to 4-aminophenol (4-AP) in the presence of Ag. The original UV-Vis spectra were shown in FIGS. 6A and B. The conversion rate vs reaction time curves were shown in FIG. 6C and D for both AgNPs and Ag-PD-CNC systems.

Since the reduction was performed with the mole of NaBH₄ exceeded that of 4-NP, it can be considered that the reaction is irrespective of borohydride content. Thus, the reaction kinetic should fit the Langmuir-Hinshel-apparent first order mode. (See Geng, Q.; Du, J. Reduction of 4-nitrophenol catalyzed by silver nanoparticles supported on polymer micelles and vesicles. RSC Adv. 2014, 4, 16425-16428.) And the apparent rate constant (kₐₚₚ) can be calculated using Equation (1):

$$- \frac{{dC}_{t}}{{d}_{t}} = {k}_{app} {C}_{t} \\ ln ( \frac{{C}_{t}}{{C}_{0}} ) = ln ( \frac{{A}_{t}}{{A}_{0}} ) = - {k}_{app} t \qquad ( 1 )$$

where Cₜ is the concentration of 4-NP at time t, kₐₚₚ is the apparent rate constant. Aₜ is the absorbance intensity from UV-Vis spectra. Thus the rate constant (k) was determined from the linear plot of ln(Aₜ/A₀) vs time in minutes. They were estimated to be 0.0456 and 0.2554 min⁻¹ for AgNPs and Ag-PD-CNCs systems, respectively (FIG. 6D). So, the concluded reaction rate for Ag-PD-CNCs was 6 times faster than the pure AgNPs under the same Ag payload.

In order to compare our product with previously reported catalysts, a summary regarding the reaction rate and turnover frequency (TOF-defined as reduced moles of 4-nitrophenol per mole catalyst per hour) was listed in Table 2. The experiments were carried out by mixing 3 mL [0.12 mM] of 4-nitrophenol with 200 μL catalyst dispersion containing 2 μg/mL of Ag. The total volume was 3.2 mL. Molecular weight of silver of 107.87 g/mol was used for calculation.

TABLE 2

| | | Cata- | | | | | |
|---|---|---|---|---|---|---|---|
| Catalyst | Temp | lyst | [4-NP] | [catalyst] | [4-NP]/ | TOF | |
| support | (K) | Type | (mM) | (mM) | [catalyst] | (h−1) | Ref |
| CNC | 298 | Pd | 0.12 | 0.0004 | 300/1 | 879.5 | 1 |
| CNC | 298 | Au | | | 30/1 | 109 | 2 |
| CNC | 298 | CuO | | | 150/1 | 885.7 | 3 |
| CNC | 298 | Cu | | | 150/1 | 1108.8 | 3 |
| PD- | 298 | Ag | 0.1125* | 0.0016* | 70.3/1 | 1077.3 | this |
| CNC | | | | | | | work |

1 Wu, X. et al. J. Mater. Chem. A 2013, 1, 8645-8652.
2 Wu, X.; et al. Environ. Sci. Nano 2014, 1, 71-79.
3 Zhou, Z et al. RSC Adv. 2013, 3, 26066-26073.

While the disclosure has been described in connection with specific embodiments thereof, it is understood that it is capable of further modifications and that this application is intended to cover any variation, use, or adaptation of the disclosure following, in general, the principles of the disclosure and including such departures from the present disclosure that come within known, or customary practice within the art to which the disclosure pertains and as may be applied to the essential features hereinbefore set forth, and as follows in the scope of the appended claims.

1. A method for producing polydopamine (PD) coated cellulose nanocrystals (CNCs), or a derivative thereof, comprising:
dispersing CNC in an aqueous medium;
optionally adjusting the pH such that it is suitable to allow the coating to occur on said CNC,
adding dopamine, or a suitable salt thereof;
allowing the polydopamine coating to occur on said CNC, and
isolating said PD coated CNC; and
wherein a step of derivatizing said PD coating is optionally before or after the step of isolation of said PD coated CNC.

2. The method of claim 1, wherein the aqueous medium is deionized water.

3. The method of claim 1, wherein the pH is from about 7 to 9.

4. A polydopamine (PD) coated cellulose nanocrystals (CNCs) prepared by the process of claim 1.

5. A method for producing metallic nanoparticles immobilized on PD coated CNC, or a derivative thereof, comprising:
contacting a PD coated CNC, or a derivative thereof, with a metallic particle source, wherein said PD coated CNC is prepared by the method comprising:
dispersing CNC in an aqueous medium;
optionally adjusting the pH such that it is suitable to allow the coating to occur on said CNC:
adding dopamine, or a suitable salt thereof;
allowing the polydopamine coating to occur on said CNC;
isolating said PD coated CNC; and
wherein a step of derivatizing said PD coating is optionally before or after the step of isolation of said PC coated CNC;
optionally adding dopamine, or a suitable salt thereof;
allowing reduction of said metallic particle source and immobilization on said PD coated CNC to occur; and
isolating said metallic nanoparticles immobilized on PD coated CNC.

6. The method of claim 5, wherein the metallic nanoparticle is silver, gold or TiO₂ nanoparticle.

7. A polydopamine (PD) coated cellulose nanocrystals (CNCs) comprising metallic nanoparticles immobilized thereon prepared by the process as defined in claim 5.

8. (canceled)

9. (canceled)

10. A method for reducing or inhibiting antibacterial activity of a bacteria, protozias fungis or algaes comprising contacting said bacteria with an antibacterial effective amount of a polydopamine (PD) coated cellulose nanocrystals (CNCs) comprising metallic nanoparticles immobilized thereon, wherein said PD coated CNC comprising metallic nanoparticle is prepared by the process comprising:
contacting a PD coated CNC, or a derivative thereof, with a metallic particle source, wherein said PD coated CNC is prepared by the method comprising:
dispersing CNC in an aqueous medium;
optionally adjusting the pH such that it is suitable to allow the coating to occur on said CNC;
adding dopamine, or a suitable salt thereonf;
allowing the polydopamine coating to occur on said CNC, and
isolating said PD coated CNC; and
wherein a step of derivatizing said PD coating is optionally before or after the step of isolation of said PD coated CNC;
optionally adding dopamine, or a suitable salt thereof;
allowing reduction of said metallic particle source and immobilization on sai PD coated CNC to occur; and
isolating said metallic nanoparticles immobilized on PD coated CNC.

11. The method of claim 10, wherein said bacterium is a Gram-positive or Gram-negative bacterium.

12. (canceled) 13. (Cancelled)

14. The method of claim 1, wherein the concentration of CNC in water is ranging from 0.1-4.0 wt %.

15. The method of claim 1, wherein the pH is from about 8.

16. The method of claim 1, wherein the dopamine is used in an amount of about 0.1-4.0 wt %.

17. The method of claim 5, wherein said metallic nanoparticles immobilized on PD coated CNC is comprising metal (0) metallic nanoparticles.

18. The method of claim 5, wherein said metallic nanoparticle is comprising silver.
